(19) United States
(12) Patent Application Publication
(10) Pub. No.: US 2010/0217720 A1
(43) Pub. Date: Aug. 26, 2010

(54) IDENTIFYING USERS FOR EFFECTIVE PROPAGATION OF CONTENT

(75) Inventors: Katherine Jones, Seattle, WA (US); Christopher Parker, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/390,261

(22) Filed: Feb. 20, 2009

(51) Int. Cl. G06Q 99/00

(52) U.S. Cl. 705/319

(57) ABSTRACT

Content may be effectively virally propagated using an arrangement that identifies prolific Internet users who are likely to share content more often and with more people. These users are termed “connectors” because they typically function as a common link between disparate groups and will thus be the center point of a large social graph. Connectors are valuable to identify because content that is received by them can be expected to propagate more quickly as compared with propagation by other users who are not connectors. Users of on-line applications (such as social networking applications) who have the greatest probability of being connectors are identified by the application of heuristics to data that pertains to the users.

### BACKGROUND

Viral propagation may be defined as a technique to spread content, messages, news, websites, or other information (collectively referred to as “content”) by word-of-mouth using the speed and distribution efficiency of the Internet. Viral propagation gets its name from the way it resembles an actual virus becoming contagious and spreading quickly (however, viral propagation generally has a positive connotation). Internet users can employ social networks, blogs (weblogs), e-mail, instant messaging (“IM”) and various other Internet-enabled media sharing websites to propagate such content to the point where it can be viewed and/or consumed by a very large number of people.

Viral propagation typically relies on the user to voluntarily engage in activities to spread the content among members of their social graph (i.e., the network of connections and relationships among people such as friends of the user, friends of friends, co-workers, etc.). In other words, a user will generally want to spread content to other users because the content is compelling or attractive in some way. For example, users may propagate the content in order to share information or the experience provided by the content with other users. Or, users may wish to engage in conversation or receive some feedback about a particular piece of content.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

Content may be effectively virally propagated using an arrangement that identifies prolific Internet users who are likely to share content more often and with more people. These users are termed “connectors” because they typically function as a common link between disparate groups and will thus be the center point of a large social graph. Connectors are valuable to identify because content that is received by them can be expected to propagate more quickly as compared with propagation by other users who are not connectors. Users of on-line applications who have the greatest probability of being connectors are identified by the application of heuristics to data that pertains to the users.

In various illustrative embodiments, a connector identifying service is configured to apply heuristics to data that is publicly exposed by an application (such as one supporting social networking) to identity connectors among a population of application users, or to calculate a connector score for the users (where the score indicates the degree to which a user is a connector). Such data can include, for example, the number of comments that are posted about a user, the number of friends that the user has identified, and the like. In other embodiments, for example when the connector identifying service is commercially aligned or is part of an application service provider, more comprehensive (and typically non-public) data may be used by the heuristics to identify connectors or calculate connector scores for application users. The heuristics can also apply different weighting factors to the data when identifying connectors and calculating connector scores.

The identified connectors may be furnished to application providers, or third parties in some cases, so that connectors can be selected to receive content that is intended to be virally propagated. For example, the connectors can be given an option to opt in to a service where they can receive breaking news, leading edge information, or other content. Many connectors can be expected to appreciate this special treatment as it fits with their self-image and behavior as natural centers of large social graphs.

The connector scores can be furnished to application providers so that they may generate rank-ordered contact lists for their users. The contact lists can explicitly list the scores, or can list contacts in order of connector score (rather than alphabetically for example) so that contacts who have the highest scores and thus greater probability of being connectors are on the top of the list. Application users will then have the option to send or forward content to selected contacts from the list to thereby maximize the opportunity for the content's viral propagation.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows an illustrative on-line environment that supports a number of application providers, users, and client computers, as well as a connector ID (identification) service;

FIG. 2 shows how application users can have social graphs of differing sizes;

FIG. 3 shows an illustrative taxonomy of content that may be propagated among the application users;

FIG. 4 shows an illustrative arrangement where the connector ID service can apply heuristics to data about application users in order to output identified connectors and/or connector scores;

FIG. 5 shows an illustrative taxonomy for public data that pertains to an application user;

FIG. 6 shows an illustrative taxonomy for non-public data that pertains to an application user; and

FIG. 7 shows an illustrative arrangement in which the connector ID service may provide connector identification and connector scores to an application provider so that an ordered list of contacts may be generated and provided to an application user.

Like reference numerals indicate like elements in the drawings.

### DETAILED DESCRIPTION

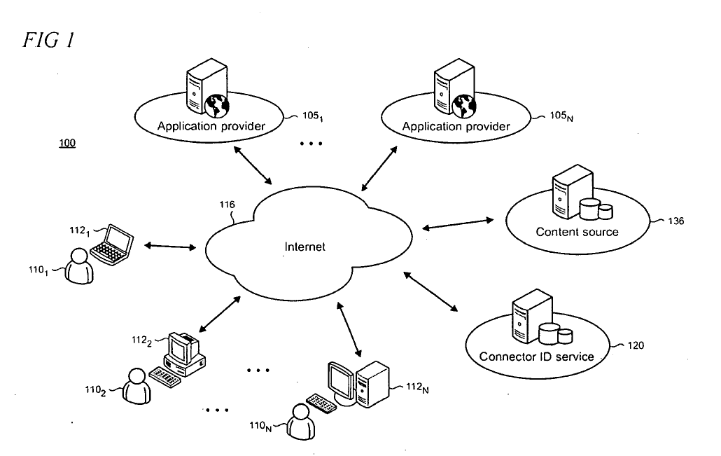

FIG. 1 shows an illustrative on-line environment 100 that supports a number of application providers 105_{1 . . . N} and users 110_{1, 2 . . . N} at respective client computers 112_{1, 2 . . . N} that are each arranged with connectivity to a public network such as the Internet 116.

The application providers 105 can serve any of a variety of on-line applications to the users 110 over the Internet 116 to support various kinds of user experiences, services, or transactions. For example, but not by way of limitation, such applications could include social networking, IM, e-mail, media sharing (such as video, audio, or photo sharing), topical forums, websites, and the like. In this particular example, one of the providers 105₁ is configured to support a social networking application that enables users to set up and personalize one or more pages of information that can be shared with others. However, it is emphasized that this particular example is intended to be illustrative and the present arrangement for identifying users for effective propagation of content is not limited to social networking scenarios.

The client computers 112 may comprise, for example, workstations, desktop and laptop PCs (personal computers), as well as mobile devices such as cell phones, handheld PCs and game devices, and the like. In some implementations, the client computers 112 can use a web browser in order to interact with the applications from the providers 105. In other implementations, a client computer 112 may utilize a specialized client-side application to support the interaction.

A connector ID service 120 is also supported in the on-line environment 100. In this example, the connector ID service 120 is arranged as a standalone entity. However, in alternative implementations, it may be desirable for the connector ID service 120 to be integrated as part of an application provider 105, or otherwise aligned with a provider, for example in a commercial or partnering arrangement.

The connector ID service 120 is configured to apply one or more heuristics to data that relates to the application users in order to identify users who are “connectors.” Connectors are generally defined as users who belong to or associate with different groups and who thus function as common links between the groups. In a social networking context, connectors may be viewed as a natural center point of a social graph that is more connected than it would otherwise be without the connector.

It is observed here that connectors tend to be more prolific users of on-line applications who have greater propensity to share content among a greater number of people as compared to non-connectors. For many connectors, propagating content is routine behavior and is often a desired way for connectors to keep in touch with members of their social graph.

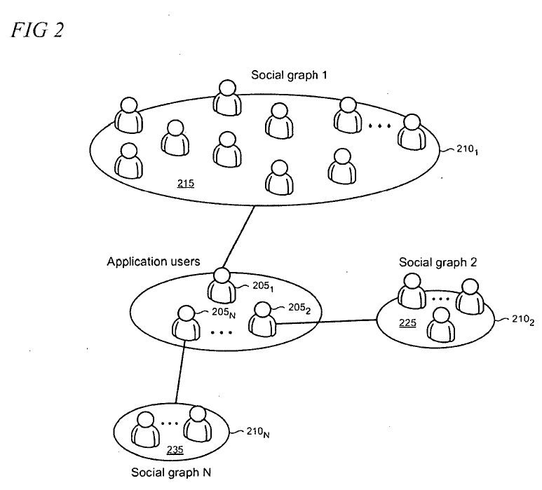

FIG. 2 shows a group of users 205_{1, 2 . . . N} who use the social networking application supported by the provider 105₁. Each user 205 has a corresponding social graph 210_{1, 2 . . . N} that includes various groups of people (respectively identified by reference numerals 215, 225, and 235). The members of a social graph can be diverse and do not necessarily need to have anything in common other than some social link to an application user 205.

As shown, application user 205₁ has relatively large social graph 215 as compared with the social graphs 225 and 235 of the users 205₂ and 205_{N}. Application user 205₁ will thus be considered a connector in this example. (It is noted that while users 205₂ and 205_{N} could also be defined as connectors in some instances, they would each have relatively lower degrees of connector-ness). It can thus be expected that content that is sent to the application user 205₁ would propagate more quickly than if the content was first sent to one of the other application users 205₂ or 205_{N}. This is because the application user 205₁, as a connector, can be viewed as a central point or node in the graph of potential recipients of the propagated content whereas the other users 205₂ and 205_{N} are more properly viewed as edge nodes in the graph and thus would be less effective starting points from which to propagate content.

Referring again to FIG. 1, a content source 136 is also supported in the on-line environment 100. Sources of content are often motivated to distribute their content virally. When these content sources are commercial entities, viral propagation can be used for example to distribute news articles, for marketing or advertising purposes, to promote a product or service, and the like. In other cases, content sources may be people looking for ways to expose their content for non-commercial reasons like entertainment for family and friends, for example, or for academic purposes.

The content source 136 may be configured as a standalone or third party source of content as shown in FIG. 1. Alternatively, the content source 136 may be directly incorporated into an application provider 105 or be arranged as part of the connector ID service in some implementations.

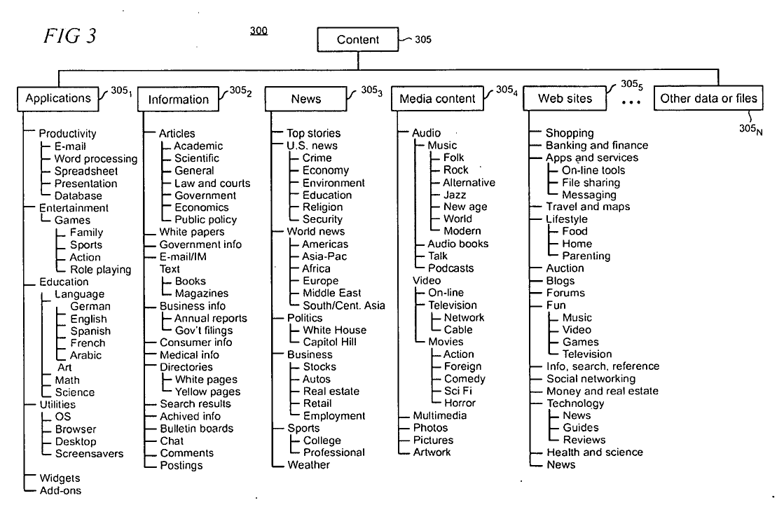

FIG. 3 shows an illustrative taxonomy 300 that includes various types of content 305 that may be provided by the source 136. However, it is emphasized that the types shown are intended to be illustrative and that other types may also be utilized to meet the needs of a particular implementation. In addition, not all of the content types in the taxonomy 300 need to be used in any given scenario. As shown, the content types in a first level of the taxonomy 300 include applications 305₁, information 305₂, news 305₃, media content 305₄, web sites 305₅, and other data or files 305_{N}. Within each content type, the taxonomy 300 expands to include additional levels (which contain one or more additional elements), sub-levels, etc.

Viral propagation over the Internet can often spread content very quickly when the content is seeded with connectors. Accordingly, the present arrangement looks to identify those application users 205 (FIG. 2) who function as connectors. Once identified, the connectors can be given an opportunity, for example, to opt in to a content service where they can receive content that may be of special interest. Such content could include breaking news, or leading edge content or other content that is timely, topical, or otherwise compelling. As connectors often like to share content, the content service can be expected to provide a benefit to them while simultaneously enabling the content that is sent to them to be effectively virally propagated.

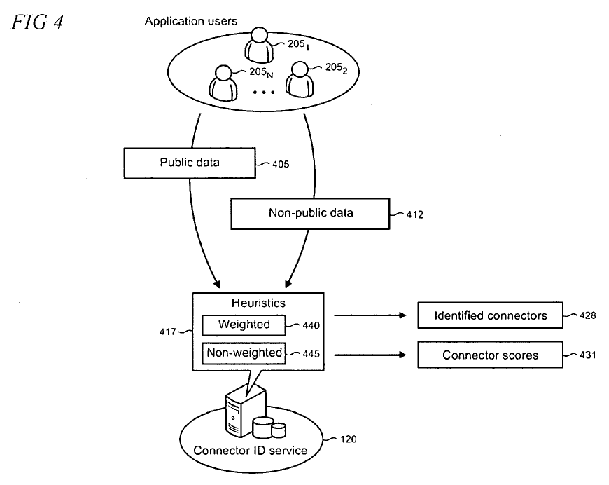

As shown in FIG. 4, the connector ID service 120 can collect public data 405 about the application users 205, or non-public data 412 about the users (where the non-public data is typically more comprehensive than the public data), or a combination of both, and then apply heuristics 417 to the collected data in order to make the inferences necessary to make predictions about the likelihood that a given user 205 is a connector. The results of the applied heuristics 417 may include identified connectors 428 among the application users 205, and/or a set of connector scores 431 that are applicable to the users 205, or a subset of the users.

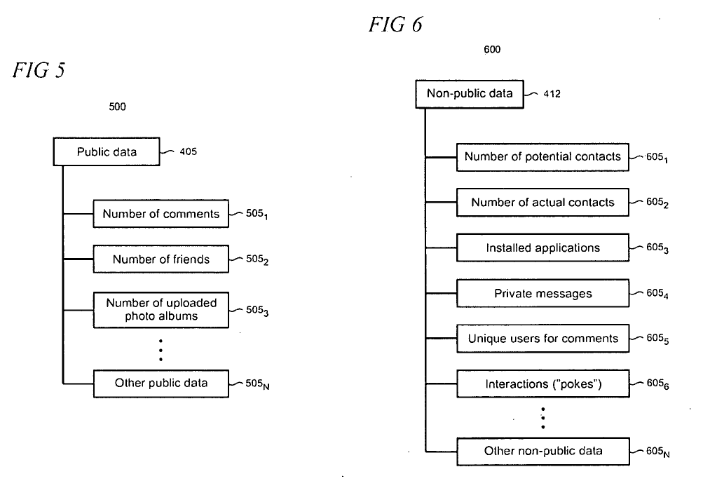

The public data 405, in this social networking example, could include data that the application exposes to the public without restriction and which is also directly observable. FIG. 5 shows an illustrative taxonomy 500 for the public data 405 which includes the number of comments 505₁ that are made about an application user 205 by others, the number of friends 505₂ that the user shows on his or her page, and other data 505_{N} that the social networking application publicly exposes. It is emphasized that the public data shown in the taxonomy 500 is intended to be illustrative and that other types of data may also be utilized as may be required to meet the needs of a specific implementation.

The non-public data 412 to which the heuristics 417 (FIG. 4) may be applied can typically include data that can be more comprehensive in nature when compared to the public data 405. The connector ID service 120 could gain access to the non-public data through an agreement with an application provider (which would, in turn, typically have a user-agreement that would give an application user 205 an option to opt in to the collection and release of such non-public information to the connector ID service for purposes of enabling the user to participate in the content service). Or, in cases when the connector ID service 120 is integrated with an application provider, it could access the non-public data 412 directly (again, typically with the consent of the application user).

The non-public data 412, in the present social networking example, could include data that the application does not expose publicly and which is not generally directly observable. FIG. 6 shows an illustrative taxonomy 600 for the non-public data 412 which includes the number of potential contacts that a particular application user 205 may have 605₁, the number of contacts the user actually has 605₂, the extent to which the user has installed utility, helper, or other types of applications 605₃ to add to the functionality of the social networking application, private messages 605₄, unique users providing comments 605₅, user interactions 605₆ (e.g., “pokes”), and other types of non-public data 605_{N}. As with the public data taxonomy 500, it is emphasized that the non-public data shown in the taxonomy 600 is intended to be illustrative and that other types of data may also be utilized as may be required to meet the needs of a specific implementation.

Returning again to FIG. 4, the connector ID service 120 will apply the heuristics 417 to the public data 405 and/or non-public data 412 in a manner where the data is weighted (as indicated by reference numeral 440) or non-weighted (as indicated by reference numeral 445), or where a combination of data weighting and non-weighting is used. However, the particular algorithms implemented by the heuristics 417 and weighting given to the data can vary by implementation.

Generally, higher numeric values for both the public and non-public data indicate a greater probability that an application user 205 is a connector. That is, a connector can be expected to have more comments 505₁ about him or her posted and a greater number of friends 505₂ on the social network, a larger number of uploaded photo albums 505₃, and so forth, than a non-connector. Thus, just to give one simple example, numeric data pertaining to a given application user 205 can be multiplied by various weighting factors and then added to achieve a connector score which is compared against some defined threshold above which a user is deemed a connector.

Non-numeric factors, such as whether the application user 205 has installed other applications 605₃, will typically be used as a weighting factor or multiplier. So, as the installation of the other applications may be considered a positive indicator of being a connector, the heuristics may take the raw connector score and multiply it by a factor of 1.1, to use an arbitrary example, in order to arrive at a total connector score.

The defined threshold can also vary by implementation, where a lower threshold will result in a greater number of connectors being identified, while a higher threshold will reduce the number of identified connectors in a given population of application users 205. Sensitivity analysis can also be performed in some implementations to compare the heuristics utilized against measurements of actual viral propagation. Adjustments to the weighting and algorithms can be made as necessary to fine tune the heuristics to enable more accurate connector prediction.

The calculation can be iterated for all of the application users 205_{1, 2 . . . N} or for a subset of the users. A list of identified connectors 428 can then be output by the connector ID service. In addition, it may be desirable to output the connector scores 431 for the application users 205.

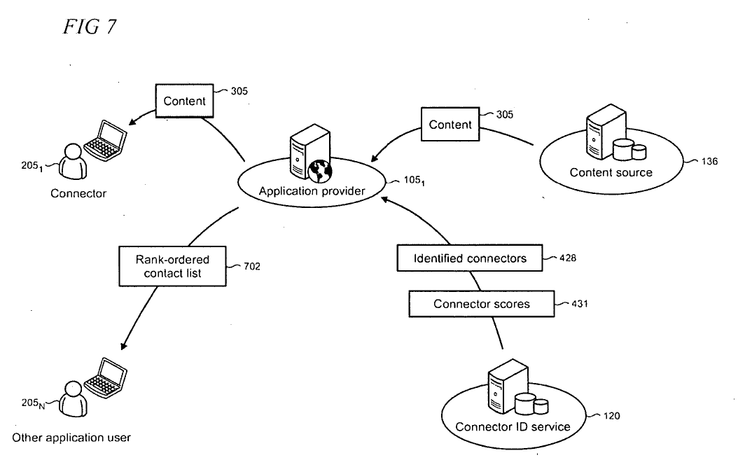

In this example as shown in FIG. 7, the connector ID service 120 may furnish the identified connectors 428 and connector scores 431 to the social networking application provider 105₁. The application provider 105₁ can then forward content 305 from the content source 136 to the identified connectors (in this case user 205₁). As noted above, it can be expected that the identified connectors will work to effectively and quickly virally propagate the content. Methods of propagation may vary by application, but users can publish content to a newsfeed, for example, or post content in public forums or a blog, forward via IM or e-mail, send or post links to the content, and the like.

In alternative arrangements, the connector ID service 120 can furnish the identified connectors 428 and connector scores 431 to third parties (not shown in FIG. 7). In such cases, the third party can use the received information in support of services that may be utilized by the application providers 105, or the third party may use the received information as part of separate applications or service offerings to Internet users generally. For example, a third party may wish to aggregate user data across multiple social networking and other applications to provide a means for connectors to identify themselves, or for users to conveniently find other connectors in other domains or contexts.

The connector scores can also be used to generate a rank-ordered contact list 702. For example, an application user 205_{N} may select and maintain a number of contacts (i.e., people in the social network supported by the provider 105, or by other external services and applications with whom the user wants to interact). Such a contact list could include, for example, e-mail addresses, IM lists, aliases, gamertags, user names, and the like. When rank-ordered, the contacts are listed in order of their connector scores 431, rather than in the more usual alphabetical form, so that identified connectors are at the top of the list followed by the other contacts in order of decreasing connector score.

The rank-ordered contact list 702 makes use of the tendency of users to pick from the top of the list when selecting contacts. That is, it has been observed that the first ten contacts in a contact list, for example, have a greater likelihood of being selected to receive forwarded content than the next ten contacts on the list and so on. The rank-ordered contact list thus operates as a benign and non-intrusive inducement to a user to increase the opportunities for viral content propagation by giving greater opportunity for connectors to be selected over non-connectors.

It should be noted that the application users 205 will typically be informed of the utilization of rank-ordering and be given an opportunity to indicate their preference as to how their contacts are ordered when displayed as a list. However, it may be expected that many users will not have a preference or may express a preference for the rank ordering as it can give them a new way to look at their contacts. In some cases, the connector scores for the user's contacts can be explicitly provided as another way of adding an interesting dimension to the social networking experience that is supported by the application.

While the preceding illustrative examples have been described in the context of social networking, it is emphasized that the present arrangement for identifying users for effective propagation of content should not be viewed as being limited to such contexts. For example, identified connectors may be used in the scenarios involving news and information applications, electronic commerce, financial transactions, library and research applications, and any of a variety of other applications where information or content is desired to be spread quickly and efficiently. For example, information and content could be utilized by telephone notification systems (i.e., “trees”) or other systems that provide notifications in the event of disasters or emergencies.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for virally propagating content over a network, the method comprising the steps of:
collecting data about users of an on-line application;
applying one or more heuristics to the collected data to identify users who a) are center points of graphs of available recipients to whom content may be propagated and b) have a propensity to share information with the graphs of available recipients; and
providing the content to the identified users.

2. The method of claim 1 in which the collected data comprises one of public data or non-public data.

3. The method of claim 1 in which the collected data is descriptive of characteristics of the users.

4. The method of claim 1 including a further step of providing a content service to the identified users.

5. The method of claim 1 in which one or more heuristics will apply weighting to at least a portion of the collected data.

6. The method of claim 1 including a further step of seeking consent from the users to collect the data.

7. A method for identifying users for effectively propagating content, the method comprising the steps of:
receiving data pertaining to users of an application, the data being indicative of metrics of the users from which inferences may be drawn as to a size of the users' social graphs;
applying one or more heuristics to the received data to predict a probability that the users of the application will propagate the content across the users' social graphs;
generating a connector score for one or more of the users, the connector score indicating the probability for one or more of the users; and
enabling the connector score to be utilized to identify users to whom the content will be directed for propagating.

8. The method of claim 7 in which the enabling comprises comparing the connector score against a defined threshold in which a connector score above the defined threshold indicates a user to be identified.

9. The method of claim 8 including a further step of providing content to the identified user, the content comprising at least one of media content, news, application, data, file, information, e-mail, IM, website, hyperlink, blog, post, or comment.

10. The method of claim 7 in which the metrics can be set by users of the application.

11. The method of claim 7 in which the application is selected from one of social networking, e-mail, IM, media sharing, topical forum, or website.

12. The method of claim 7 including a further step of providing an inducement to a user to propagate content.

13. The method of claim 12 in which the inducement comprises a rank-ordered list of contacts of the user, the rank-ordered list being generated in view of the connector score.

14. The method of claim 13 in which the contacts include at least one of e-mail address, IM address, alias, gamertag, or user name.

15. A method for providing a social networking application to a plurality of on-line users, the method comprising the steps of:
enabling the users to set selectable metrics supported by the application;
collecting data that is descriptive of the metrics;
applying one or more heuristics to the collected data to make inferences as to the probability that a given user is a connector, a connector being a center point in a graph of available content recipients to whom content may be shared, and further having a greater likelihood of forwarding the content to recipients in the graph compared with a non-connector; and
targeting content to the connector for propagation to the recipients in the graph.

16. The method of claim 15 in which the metrics are publicly observable and include at least one of a plurality of comments about a user or identified friends of a user.

17. The method of claim 15 including a further step of collecting non-public data, the non-public data including at least one of potential contacts of a user, private messages exchanged among users, unique users providing comments, user interactions, utilization of applications, or actual contacts of a user.

18. The method of claim 15 including a further step of applying weighting to at least a portion of the collected data.

19. The method of claim 15 including a further step of generating a connector score for each of the plurality of on-line users.

20. The method of claim 19 including a further step of generating a rank-ordered list of the plurality of on-line users using the connector score.
